(19) United States
(12) Patent Application Publication
(10) Pub. No.: US 2025/0309546 A1
(43) Pub. Date: Oct. 2, 2025

(54) DOUBLE SLOT ANTENNA

(71) Applicant: KYOCERA AVX Components (San Diego), Inc., San Diego, CA (US)

(72) Inventors: Tzu Ling Chiu, New Taipei City (TW); Jui Feng Wu, New Taipei City (TW)

(21) Appl. No.: 19/092,725

(22) Filed: Mar. 27, 2025

Related U.S. Application Data
(60) Provisional application No. 63/571,859, filed on Mar. 29, 2024.

(51) Int. Cl. H01Q 13/10; H01Q 1/22; H01Q 5/30

(52) U.S. Cl. CPC H01Q 13/10; H01Q 1/2266; H01Q 5/30

(57) ABSTRACT

A double slot antenna is provided. The double slot antenna includes an antenna element defining a reference plane, the antenna element being partially enclosed by a metal frame along the reference plane. The double slot antenna further includes an inner slot defined within the antenna element along the reference plane. The double slot antenna further includes an outer slot defined between the antenna element and a metal frame along the reference plane. The metal frame comprises a notch.

### PRIORITY CLAIM

The present application is based on and claims priority to U.S. Provisional Application 63/571,859 having a filing date of Mar. 29, 2024, which is incorporated by reference herein.

### FIELD

Example aspects of the present disclosure relate generally to antennas and antenna assemblies.

### BACKGROUND

Antennas are used to facilitate wireless communication between electronic devices. In some instances, mobile computing devices (e.g., laptops, cellular phones) use antennas such as wireless wide area network (WWAN) antennas, to communicate over, for instance, a telecommunication cellular network, such as a 4G, LTE, 5G, or other cellular network.

### SUMMARY

Aspects and advantages of embodiments of the present disclosure will be set forth in part in the following description, or can be learned from the description, or can be learned through practice of the embodiments.

One example aspect of the present disclosure is directed to a double slot antenna. The double slot antenna includes an antenna element defining a reference plane, the antenna element being partially enclosed by a metal frame along the reference plane. The double slot antenna further includes an inner slot defined within the antenna element along the reference plane. The double slot antenna further includes an outer slot defined between the antenna element and a metal frame along the reference plane. The metal frame comprises a notch.

Another example aspect of the present disclosure is directed to a double slot antenna assembly. The double slot antenna assembly includes a metal frame comprising a first antenna region, the first antenna region having a notch extending through an outer periphery of the metal frame. The double slot antenna assembly further includes a first antenna element positioned within the first antenna region to define an outer slot between the first antenna element and the metal frame, the first antenna element comprising an inner slot.

Another example aspect of the present disclosure is directed to a mobile computing device. The mobile computing device includes a metal frame. The mobile computing device further includes an antenna element defining a reference plane, the antenna element being partially enclosed by the metal frame along the reference plane. The mobile computing device further includes an inner slot defined within the antenna element along the reference plane. The mobile computing device further includes an outer slot defined between the antenna element and a metal frame along the reference plane. The metal frame comprises a notch.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 depicts a plan view of an example double slot antenna according to example embodiments of the present disclosure;

FIGS. 2A-2E depict plan views of example double slot antennas according to example embodiments of the present disclosure;

FIG. 3 depicts a plan view of an example double slot antenna according to example embodiments of the present disclosure;

FIG. 4 depicts a plan view of an example double slot antenna assembly according to example embodiments of the present disclosure;

FIG. 5 depicts a plan view of an example double slot antenna assembly according to example embodiments of the present disclosure;

FIGS. 6A-6C depict a mobile computing device according to example embodiments of the present disclosure;

FIG. 7 depicts an example return loss of an example double slot antenna according to example embodiments of the present disclosure;

FIG. 8 depicts an example efficiency of an example double slot antenna according to example embodiments of the present disclosure.

Repeat use of reference characters in the present specification and drawings is intended to represent same or analogous features or elements of the invention.

### DETAILED DESCRIPTION

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations. As used herein, the use of the term “about” in conjunction with a numerical value is intended to refer to within 10% of the numerical value.

Example aspects of the present disclosure relate generally to antennas in mobile computing devices. The antennas provided herein may be configured to communicate over a variety of different frequency bands/protocols. For instance, the antenna assemblies of the present disclosure may be configured to communicate over frequency bands associated with GPS, Wi-Fi, Bluetooth, UWB, 2G, 3G, 4G, LTE, and 5G systems and/or protocols. In some examples, the antenna assemblies of the present disclosure may be used for MIMO applications. Antenna design within mobile computing devices (e.g., laptops, cellular phones) proves challenging as the physical dimensions of the antenna must meet the antenna performance specifications while being enclosed within the device. These challenges are compounded for antennas such as wireless wide area network (WWAN) antennas that operate over a wide range with multiple frequency bands. As such, an antenna configuration for providing consistent operation over multiple frequency bands is included.

The systems and methods according to example embodiments of the present disclosure provide a number of technical effects and benefits. For instance, the systems and methods according to example embodiments of the present disclosure can provide for improved antenna operation over multiple frequency bands while still being enclosed within the physical dimensions of, for instance, a laptop device.

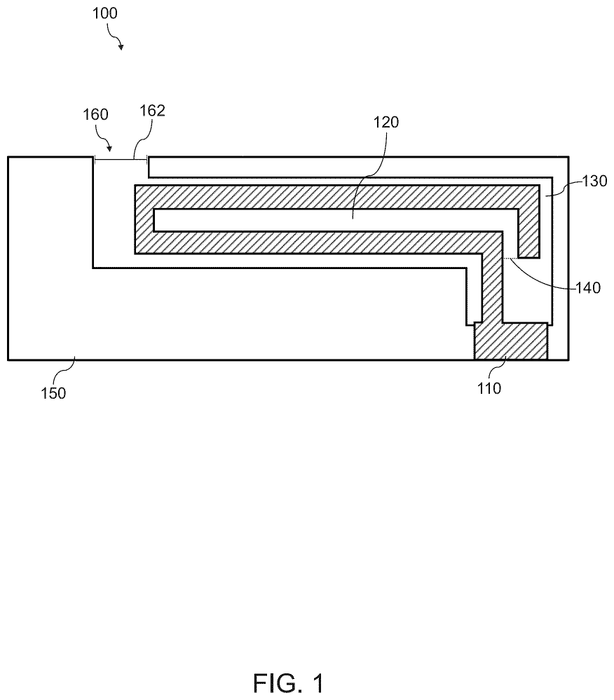

FIG. 1 depicts a plan view of an example double slot antenna according to example embodiments of the present disclosure. The plan view of the double slot antenna shown in FIG. 1 is shown as a two-dimensional representation of the double slot antenna along a reference plane. In some embodiments, the double slot antenna 100 may be WWAN antenna. In some embodiments, double slot antenna 100 may be configured to communicate over frequency bands associated with GPS, Wi-Fi, Bluetooth, UWB, 2G, 3G, 4G, LTE, and 5G systems and/or protocols.

Double slot antenna 100 includes antenna element 110. As illustrated in FIG. 1, antenna element 110 may be a substantially planar antenna element such that the antenna element 110 defines a reference plane. As seen in FIG. 1, antenna element 110 may be positioned within a metal frame 150. In some embodiments, metal frame 150 may be a component of a mobile computing device such as a laptop.

The double slot antenna 100 further includes inner slot 120. Inner slot 120 is defined within antenna element 110 along the reference plane. The double slot antenna 100 further includes outer slot 130. Outer slot 130 is defined between the antenna element 110 and the metal frame 150 along the reference plane. The outer slot 130 and metal frame 150 may form a portion of the double slot antenna 100. In some embodiments, inner slot 120 and outer slot 130 may be defined as airgap slots such that no metal or electrically conductive components exist within the slots along the reference plane.

The antenna element 110 may be positioned within metal frame 150 such that antenna element 110 is partially enclosed by metal frame 150 along the reference plane. As such, metal frame 150 includes notch 160. Notch 160 may be defined as an opening in metal frame 150 such that no metal or electrically conductive components exist within notch 160 along the reference plane. Notch 160 may have a width 162 of about 1 mm to about 15 mm, such as about 10 mm.

Double slot antenna 100 may be configured to operate over multiple frequency bands. As such, structural components of the double slot antenna 100 may be associated with specific frequency bands. For example, structural components (e.g., inner slot, outer slot, notch) of the double slot antenna 100 may be associated with communication over various frequency bands. For example, outer slot 130 may be associated with a first frequency band. Inner slot 120 may be associated with a second frequency band. The first frequency band may be about 1700 MHz megahertz [MHz] and the second frequency band may be about 2100 MHz. In some embodiments, outer slot 130 is further associated with a third frequency band. The third frequency band may be about 2700 MHZ.

In some embodiments, antenna element 110 may be associated with middle-band portion of the antenna's operating frequencies (e.g., about 2400 MHz to about 3000 MHz) and a high-band portion of the antenna's operating frequencies (e.g., about 3300 to about 3800 MHZ). In some embodiments, outer slot 130 may be associated with frequencies between about 698 MHz and about 960 MHz.

In some embodiments, notch 160 may also be associated with one or more frequencies. For example, notch 160 may be associated with frequencies from about 1400 MHz to about 1900 MHZ, such as about 1700 MHz. In some embodiments, metal frame 150 may also be associated with one or more frequencies. For example, metal frame 150 may be associated with a frequency that is about 617 MHz.

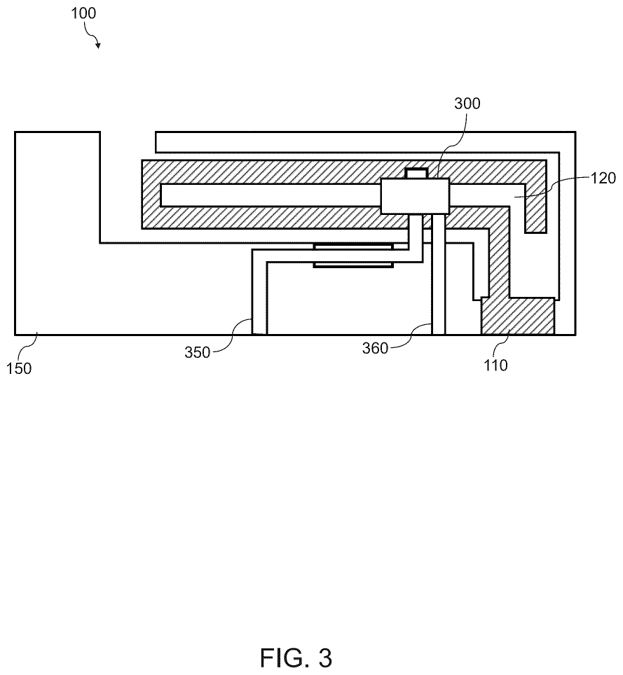

Double slot antenna 100 may further include an impedance matching component configured to provide impedance matching to double slot antenna 100. In some embodiments, double slot antenna 100 may include the impedance matching component described herein in reference to FIG. 3.

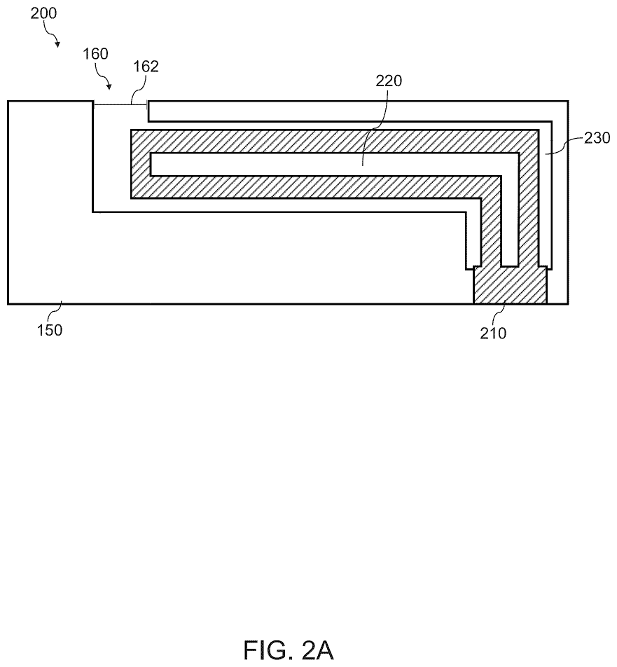

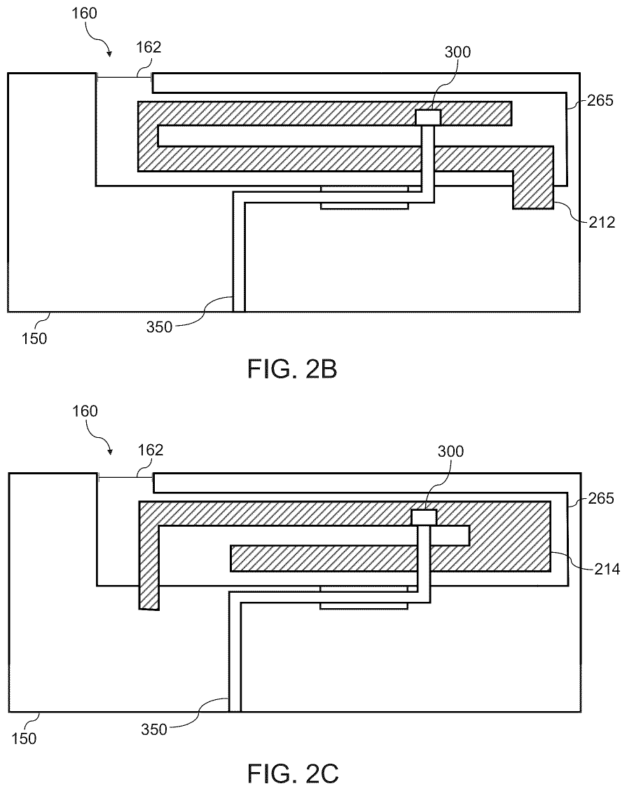

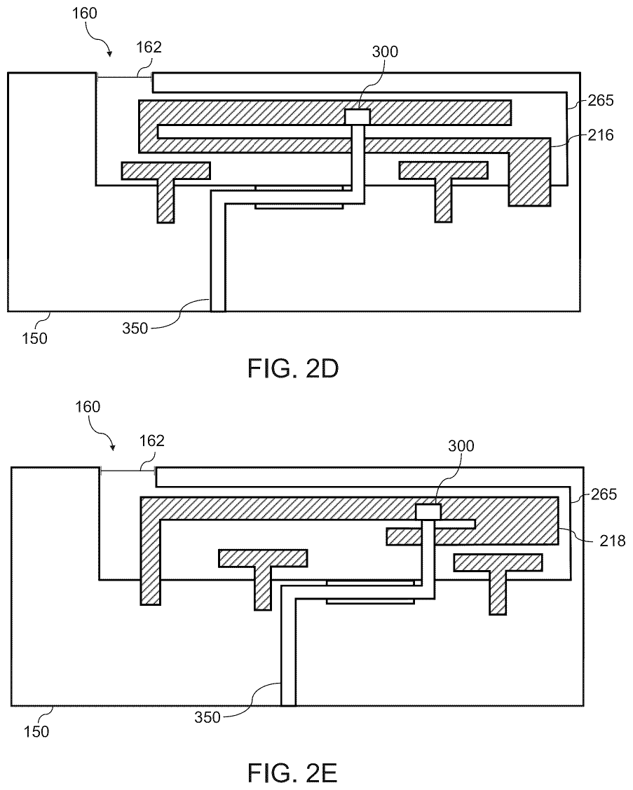

In some embodiments, inner slot 120 may be partially enclosed by antenna element 110 along the reference plane. As shown in FIG. 1, antenna element 110 may include an opening 140 along the reference plane such that the inner slot 120 directly connects to the outer slot 130 as shown in FIG. 1. Those of ordinary skill in the art, using the disclosures provided herein will understand that antenna elements other than antenna element 110 may be used without deviating from the scope of the present disclosure. For example, inner slot 120 may be fully enclosed by antenna element 110 along the reference plane as described below in reference to FIG. 2A.

FIGS. 2A-2E show double slot antennas according to example aspects of the present disclosure. In some embodiments, the double slot antennas may be WWAN antennas. In some embodiments, the double slot antennas may be configured to communicate over frequency bands associated with GPS, Wi-Fi, Bluetooth, UWB, 2G, 3G, 4G, LTE, and 5G systems and/or protocols.

Referring now to FIG. 2A, double slot antenna 200 includes antenna element 210. As illustrated in FIG. 2A, antenna element 210 may be a substantially planar antenna element such that the antenna element 210 defines a reference plane. As seen in FIG. 2A, antenna element 210 may be positioned within a metal frame 150. In some embodiments, metal frame 150 may be a component of a mobile computing device such as a laptop.

The double slot antenna 200 further includes inner slot 220. Inner slot 220 is defined within antenna element 210 along the reference plane. The double slot antenna 200 further includes outer slot 230. Outer slot 230 is defined between the antenna element 210 and the metal frame 150 along the reference plane. The outer slot 230 and metal frame 150 may form a portion of the double slot antenna 200. In some embodiments, inner slot 220 and outer slot 230 may be defined as airgap slots such that no metal or electrically conductive components exist within the slots along the reference plane. As seen in FIG. 2A, inner slot 220 is fully enclosed by antenna element 210 along the reference plane. As such, inner slot 220 does not directly connect to outer slot 230. The antenna element 210 may be positioned within metal frame 150 such that antenna element 210 is partially enclosed by metal frame 150 along the reference plane. As such, metal frame 150 includes notch 160. Notch 160 may be defined as an opening in metal frame 150 such that no metal or electrically conductive components exist within notch 160 along the reference plane. Notch 160 may have a width 162 of about 1 mm to about 15 mm, such as about 10 mm.

Double slot antenna 200 may be configured to operate over multiple frequency bands. As such, structural components of the double slot antenna 200 may be associated with specific frequency bands. For example, structural components (e.g., inner slot, outer slot, notch) of the double slot antenna 200 may be associated with communication over various frequency bands. For example, outer slot 230 may be associated with a first frequency band. Inner slot 220 may be associated with a second frequency band. The first frequency band may be about 1700 MHz and the second frequency band may be about 2100 MHz. In some embodiments, outer slot 230 is further associated with a third frequency band. The third frequency band may be about 2700 MHZ.

In some embodiments, antenna element 210 may be associated with middle-band portion of the antenna's operating frequencies (e.g., about 2400 MHz to about 3000 MHz) and a high-band portion of the antenna's operating frequencies (e.g., about 3300 to about 3800 MHZ). In some embodiments, outer slot 230 may be associated with frequencies between about 698 MHz and about 960 MHz.

In some embodiments, notch 160 may also be associated with one or more frequencies. For example, notch 160 may be associated with frequencies from about 1400 MHz to about 1900 MHZ, such as about 1700 MHz. In some embodiments, metal frame 150 may also be associated with one or more frequencies. For example, metal frame 150 may be associated with a frequency that is about 617 MHz.

Double slot antenna 200 may further include an impedance matching component configured to provide impedance matching to double slot antenna 200. In some embodiments, double slot antenna 200 may include the impedance matching component described herein in reference to FIG. 3.

While double slot antenna 100 of FIG. 1 and double slot antenna 200 of FIG. 2A are discussed with reference to antenna elements 110, 210, those of ordinary skill in the art will understand that the double slot antenna of the present disclosure may include any applicable antenna element. For example, FIGS. 2B-2E depict alternative antenna elements 212, 214, 216, and 218 that may be implemented by a double slot antenna according to example embodiments of the present disclosure. As shown in FIGS. 2B-2E, antenna elements 212, 214, 216, and 218 may be positioned within a rectangular antenna region 265 of metal frame 150. Accordingly, any double slot antenna provided herein may include an antenna element positioned within a rectangular antenna region 265 of metal frame 150. Further, a double slot antenna according to example embodiments may include an impedance matching component 300 and a feed line coupled to impedance matching component 300 as shown in FIGS. 2B-2E.

FIG. 3 depicts an impedance matching component for a double slot antenna according to example embodiments of the present disclosure. While FIG. 3 is discussed with reference to double slot antenna 100 of FIG. 1, those of ordinary skill in the art, using the disclosures provided herein will understand that any double slot antenna such as those shown in FIGS. 2A-2E may be used without deviating from the scope of the present disclosure.

Impedance matching component 300 is configured to provide impedance matching to the double slot antenna. In some embodiments, impedance matching component 300 may include switching device and/or one or more inductive and/or capacitive components (e.g., RLC component, ILC component). The impedance matching component 300 may include a tunable capacitor. Switch control line 360 may control impedance matching component 300 (e.g., switching device). In some embodiments, feed line 350 may be coupled to impedance matching component 300. As shown in FIG. 3, impedance matching component 300 may be operably coupled to antenna element 110. As such, impedance matching component 300 may partially overlap inner slot 120.

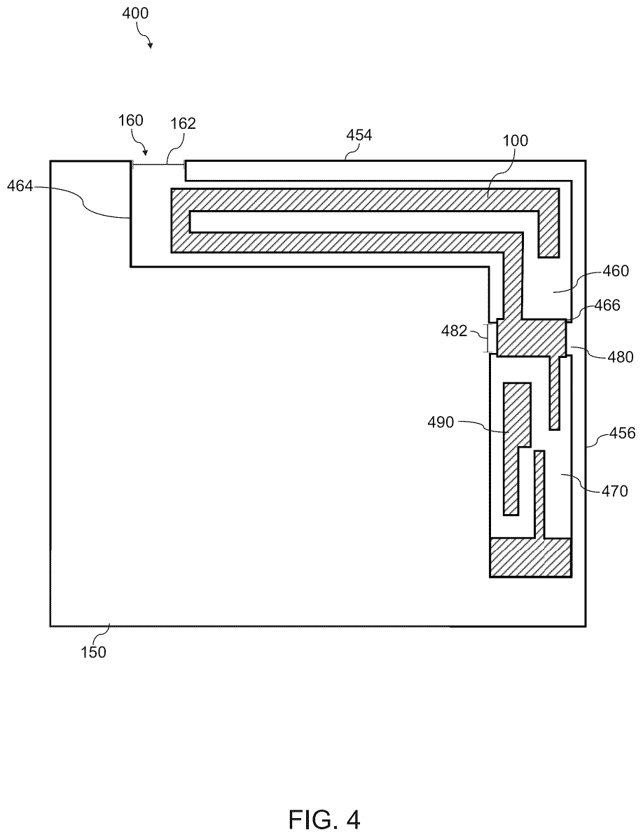

FIG. 4 depicts a plan view of an example double slot antenna assembly according to example embodiments of the present disclosure. Double slot antenna assembly 400 is described below with reference to double slot antenna 100 of FIG. 1, although those of ordinary skill in the art using the disclosure provided herein will understand that double slot antenna assembly 400 may include any applicable double slot antenna, such as any double slot antenna provided herein. Double slot antenna assembly 400 may be used for diversity, MIMO, or for other frequency bands.

Double slot antenna assembly 400 includes metal frame 150. In some embodiments, metal frame 150 may be a component of a mobile computing device such as a laptop. The metal frame 150 includes an antenna region 460. Antenna region 460 includes notch 160 extending through an outer periphery of the metal frame 150.

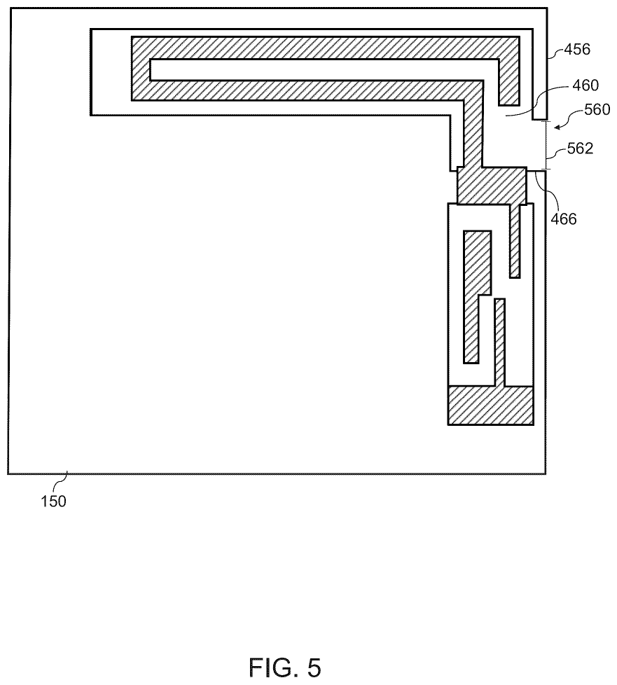

In some embodiments, antenna region 460 may be an L-shaped antenna region positioned along a first edge 454 and a second edge 456 of metal frame 150. As such, antenna region 460 may extend along the first edge 454 and second edge 456 from a first endpoint 464 to a second endpoint 466. As stated above, antenna region 460 includes a notch 160 extending through an outer periphery of the metal frame 150. Notch 160 may have a width 162 of about 1 mm to about 15 mm, such as about 10 mm. As shown in FIG. 4, notch 160 may extend through a first edge 454 of metal frame 150 at first endpoint 464 of antenna region 460 (e.g., L-shaped antenna region). Alternatively, notch 160 may extend through the metal frame 150 at another position, such as through second edge 456 of metal frame 150 at second endpoint 466. For example, as shown in FIG. 5, notch 560 may extend through a second edge 456 of metal frame 150 at second endpoint 466 of antenna region 460 (e.g., L-shaped antenna region). Notch 560 may have a width 562 of about 1 mm to about 15 mm, such as about 10 mm.

Referring back to FIG. 4, double slot antenna assembly 400 may further include antenna region 470. Antenna region 470 may be a rectangular antenna region and be fully enclosed by metal frame 150. Double slot antenna assembly 400 may further include a bridge portion 480 of metal frame 150 separating antenna region 460 (e.g., L-shaped antenna region) from antenna region 470 (e.g., rectangular antenna region). As such, bridge portion 480 may have a width 482 corresponding to the length between antenna region 460 and antenna region 470. In some embodiments, bridge portion 480 may have a width 482 of about 4 mm to about 9 mm, such as about 7 mm.

Antenna 490 may be positioned within antenna region 470. In some embodiments, antenna 490 may be coupled to bridge portion 480 to, for example, offer structural support to antenna 490. In some embodiments, antenna 490 may be a double slot antenna. Double slot antenna assembly 400 may further include double slot antenna 100 (e.g., first antenna) positioned within antenna region 460. In some embodiments, double slot antenna 100 may also be coupled to bridge portion 480 to, for example, offer structural support to double slot antenna 100. In some embodiments, antenna 490 and/or double slot antenna 100 may be an application specific antenna, such as a MIMO antenna, an LTE antenna, a GPS antenna, a Wi-Fi antenna, a Bluetooth antenna, or a UWB antenna.

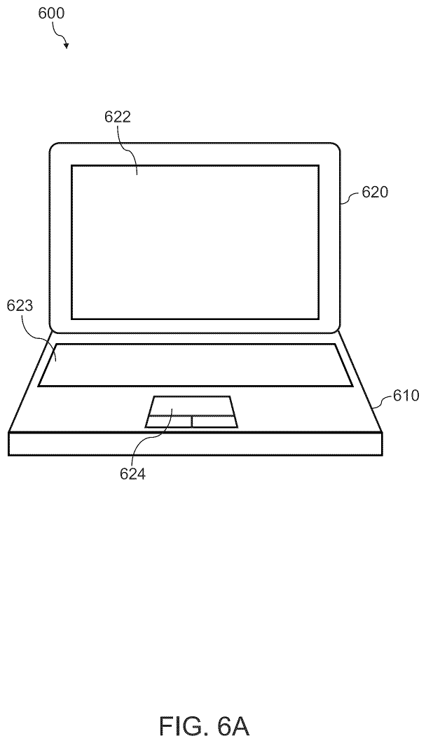

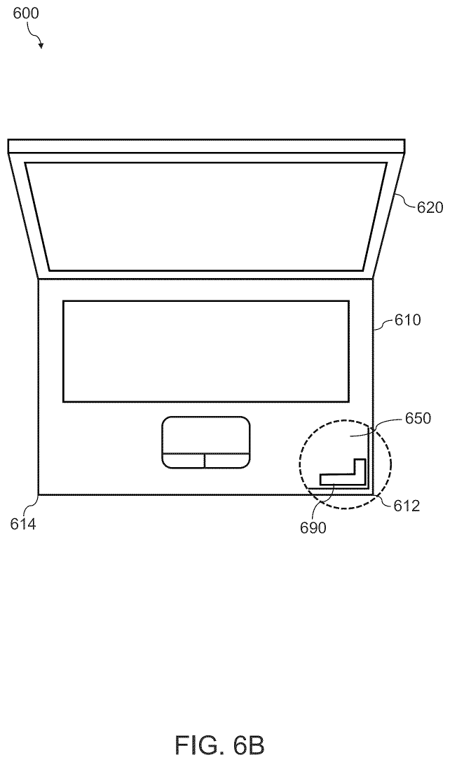

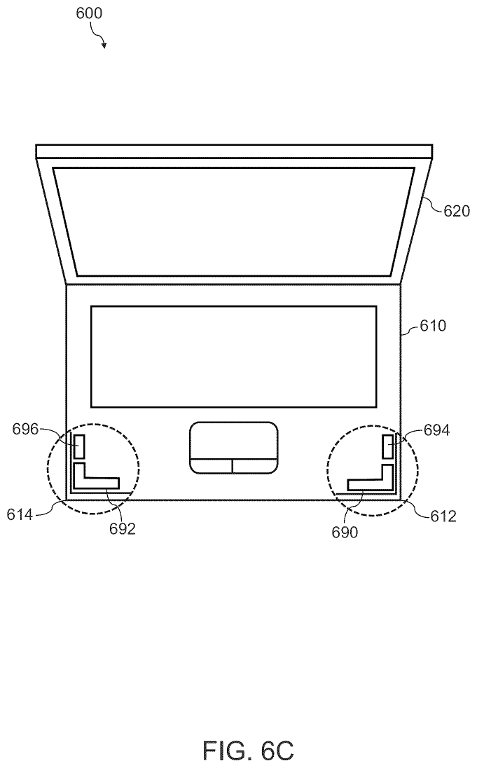

FIGS. 6A-6C illustrate a mobile computing device according to example embodiments of the present disclosure.

Referring now to FIG. 6A, a mobile computing device 600 is illustrated. As shown, mobile computing device 600 may be a laptop. Mobile computing device 600 may include a main body 610 that is pivotally coupled to a display member 620. In some embodiments, mobile computing device 600 may include one or more input/output devices such as an electronic screen 622 (e.g., display screen, touch screen), a key pad 623 (e.g., keyboard), and/or a touch pad 624. Main body 610 may be configured to house one or more one or more metal frames as described herein.

Now referring to FIG. 6B, a top down exploded view of mobile computing device 600 is shown. As stated above, main body 610 of mobile computing device 600 may be configured to house one or more metal frames 650. As shown in FIG. 6B, metal frame 650 may be positioned within main body 610 of mobile computing device 600. In some embodiments, metal frame 650 may span the length and width of main body 610.

Mobile computing device 600 further includes double slot antenna 690. Double slot antenna 690 may be any applicable double slot antenna, such as double slot antenna 100 described in FIG. 1 or double slot antenna 200 described in FIG. 2. Double slot antenna 690 may be positioned proximate a corner of the main body 610 not defined by display member 620, such as main body corner 612 or main body corner 614.

As shown in FIG. 6C, mobile computing device 600 may include a first double slot antenna 690 positioned proximate main body corner 612 and a second double slot antenna 692 positioned proximate main body corner 614. Double slot antenna 690 and double slot antenna 692 may be any applicable double slot antenna, such as double slot antenna described herein. In some embodiments, double slot antennas 690, 692 may be application specific antennas, such as MIMO antennas, LTE antennas, GPS antennas, Wi-Fi antennas, Bluetooth antennas, or UWB antennas. For example, double slot antenna 690 may be WWAN main antenna and double slot antenna 692 may be a WWAN aux antenna. In some embodiments, mobile computing device 600 may further include a first MIMO antenna 694 and a second MIMO antenna 696.

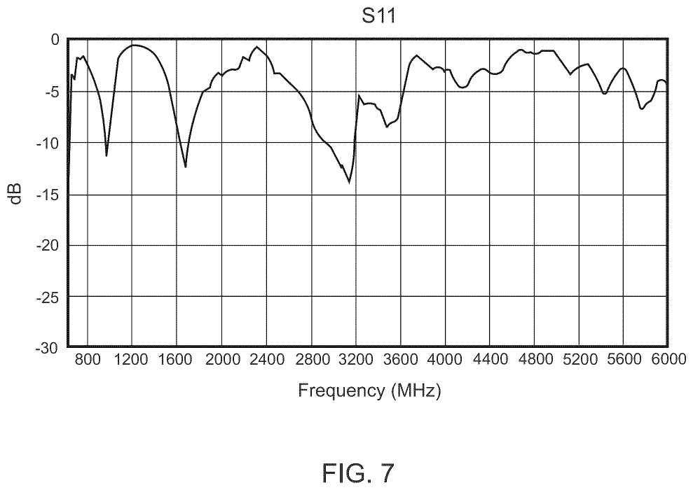

FIG. 7 depicts an example return loss of a double slot antenna according to example embodiments of the present disclosure. As shown in FIG. 7, the double slot antenna operates with minimum return loss over a large bandwidth.

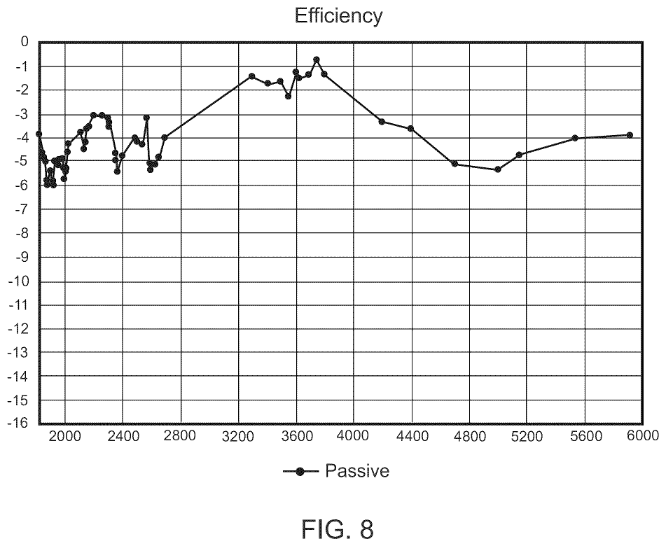

FIG. 8 depicts an example efficiency of an example double slot antenna according to example embodiments of the present disclosure. As shown in FIG. 8, the double slot antenna operates efficiently over a large bandwidth.

One example aspect of the present disclosure is directed to a double slot antenna. The double slot antenna includes an antenna element defining a reference plane, the antenna element being partially enclosed by a metal frame along the reference plane. The double slot antenna further includes an inner slot defined within the antenna element along the reference plane. The double slot antenna further includes an outer slot defined between the antenna element and a metal frame along the reference plane. The metal frame comprises a notch.

In some examples, the metal frame comprises a notch such that the outer slot is not fully enclosed by the metal frame.

In some examples, the notch has a width of about 1 mm to about 15 mm.

In some examples, the double slot antenna further includes an impedance matching component operably coupled to the antenna element, the impedance matching component configured to provide impedance matching to the double slot antenna, the impedance matching component at least partially overlapping the inner slot.

In some examples, the outer slot is associated with a first frequency band and the inner slot is associated with a second frequency band.

In some examples, the first frequency band is 1700 MHz and the second frequency band is 2100 MHz.

In some examples, the outer slot is further associated with a third frequency band, the third frequency band being 2700 MHZ.

In some examples, the inner slot is fully enclosed by the antenna element along the reference plane.

In some examples, the inner slot is partially enclosed by the antenna element along the reference plane.

In some examples, the antenna element is a WWAN antenna element.

Another example aspect of the present disclosure is directed to a double slot antenna assembly. The double slot antenna assembly includes a metal frame comprising a first antenna region, the first antenna region having a notch extending through an outer periphery of the metal frame. The double slot antenna assembly further includes a first antenna element positioned within the first antenna region to define an outer slot between the first antenna element and the metal frame, the first antenna element comprising an inner slot.

In some examples, the double slot antenna assembly further includes an impedance matching component operably coupled to the first antenna element, the impedance matching component configured to provide impedance matching to the double slot antenna assembly, the impedance matching component at least partially overlapping the inner slot.

In some examples, the first antenna region is an L-shaped antenna region positioned along a first edge and a second edge of the metal frame.

In some examples, the double slot antenna assembly further includes a rectangular antenna region, the rectangular antenna region being fully enclosed by the metal frame; and a bridge portion separating the L-shaped antenna region from the rectangular antenna region.

In some examples, the notch extends through the first edge of the metal frame at an endpoint of the L-shaped antenna region.

In some examples, the notch extends through the second edge of the metal frame at an endpoint of the L-shaped antenna region.

In some examples, the double slot antenna assembly further includes a MIMO antenna positioned within the rectangular antenna region.

In some examples, the first antenna element is a WWAN antenna.

Another example aspect of the present disclosure is directed to a mobile computing device. The mobile computing device includes a metal frame. The mobile computing device further includes an antenna element defining a reference plane, the antenna element being partially enclosed by the metal frame along the reference plane. The mobile computing device further includes an inner slot defined within the antenna element along the reference plane. The mobile computing device further includes an outer slot defined between the antenna element and a metal frame along the reference plane. The metal frame comprises a notch.

In some examples, the mobile computing device comprises a laptop.

While the present subject matter has been described in detail with respect to specific example embodiments thereof, it will be appreciated that those skilled in the art, upon attaining an understanding of the foregoing can readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A double slot antenna, comprising:
an antenna element defining a reference plane, the antenna element being partially enclosed by a metal frame along the reference plane;
an inner slot defined within the antenna element along the reference plane; and
an outer slot defined between the antenna element and a metal frame along the reference plane;
wherein the metal frame comprises a notch.

2. The double slot antenna of claim 1, wherein the metal frame comprises a notch such that the outer slot is not fully enclosed by the metal frame.

3. The double slot antenna of claim 2, wherein the notch has a width of about 1 mm to about 15 mm.

4. The double slot antenna of claim 1, further comprising:
an impedance matching component operably coupled to the antenna element, the impedance matching component configured to provide impedance matching to the double slot antenna, the impedance matching component at least partially overlapping the inner slot.

5. The double slot antenna of claim 1, wherein the outer slot is associated with a first frequency band and the inner slot is associated with a second frequency band.

6. The double slot antenna of claim 5, wherein the first frequency band is 1700 MHz and the second frequency band is 2100 MHz.

7. The double slot antenna of claim 6, wherein the outer slot is further associated with a third frequency band, the third frequency band being 2700 MHZ.

8. The double slot antenna of claim 1, wherein the inner slot is fully enclosed by the antenna element along the reference plane.

9. The double slot antenna of claim 1, wherein the inner slot is partially enclosed by the antenna element along the reference plane.

10. The double slot antenna of claim 1, wherein the antenna element is a WWAN antenna element.

11. A double slot antenna assembly, comprising:
a metal frame comprising a first antenna region, the first antenna region having a notch extending through an outer periphery of the metal frame; and
a first antenna element positioned within the first antenna region to define an outer slot between the first antenna element and the metal frame, the first antenna element comprising an inner slot.

12. The double slot antenna assembly of claim 11, further comprising:
an impedance matching component operably coupled to the first antenna element, the impedance matching component configured to provide impedance matching to the double slot antenna assembly, the impedance matching component at least partially overlapping the inner slot.

13. The double slot antenna assembly of claim 11, wherein the first antenna region is an L-shaped antenna region positioned along a first edge and a second edge of the metal frame.

14. The double slot antenna assembly of claim 13, further comprising:
a rectangular antenna region, the rectangular antenna region being fully enclosed by the metal frame; and
a bridge portion separating the L-shaped antenna region from the rectangular antenna region.

15. The double slot antenna assembly of claim 14, wherein the notch extends through the first edge of the metal frame at an endpoint of the L-shaped antenna region.

16. The double slot antenna assembly of claim 14, wherein the notch extends through the second edge of the metal frame at an endpoint of the L-shaped antenna region.

17. The double slot antenna assembly of claim 14, further comprising:
a MIMO antenna positioned within the rectangular antenna region.

18. The double slot antenna assembly of claim 11, wherein the first antenna element is a WWAN antenna.

19. A mobile computing device, comprising:
a metal frame;
an antenna element defining a reference plane, the antenna element being partially enclosed by the metal frame along the reference plane;
an inner slot defined within the antenna element along the reference plane; and
an outer slot defined between the antenna element and a metal frame along the reference plane;
wherein the metal frame comprises a notch.

20. The mobile computing device of claim 19, wherein the mobile computing device comprises a laptop.
